(19) United States
(12) Patent Application Publication
(10) Pub. No.: US 2024/0417493 A1
(43) Pub. Date: Dec. 19, 2024

(54) PROCESS FOR PREPARING POLYMETHYLMETHACRYLATE CONTAINING HIGH CONCENTRATION OF GADOLINIUM OXIDE NANOMETRIC PARTICLES

(71) Applicants: Istituto Nazionale di Fisica Nucleare, Frascati, Roma (IT); Universita Degli Studi Di Genova, Genova (IT)

(72) Inventors: Bianca BOTTINO, Genova (IT); Gemma TESTERA, Genova (IT); Alessio CAMINATA, Genova (IT); Marco PALLAVICINI, Genova (IT); Anna MARINI, Genova (IT); Davide PEDDIS, Genova (IT); Sawssen SLIMANI, Genova (IT); Dario CAVALLO, Genova (IT); Silvia VICINI, Genova (IT)

(73) Assignees: Istituto Nazionale di Fisica Nucleare, Frascati, Roma (IT); Universita Degli Studi Di Genova, Genova (IT)

(21) Appl. No.: 18/706,788

(22) PCT Filed: Nov. 3, 2022
(86) PCT No.: PCT/IB2022/060579

§ 371 Date: May 2, 2024

(30) Foreign Application Priority Data
Nov. 4, 2021 (IT) 102021000028130

(51) Int. Cl. C08F 2/44; C08F 2/00; C08F 120/14; C08K 9/04

(52) U.S. Cl. CPC C08F 2/44; C08F 2/001; C08F 120/14; C08K 9/04; C08K 2201/005; C08K 2201/011

(57) ABSTRACT

The present invention relates to a new process for preparing polymethylmethacrylate (PMMA) comprising nanometric particles of gadolinium oxide (Gd₂O₃) at high concentration, and plates or cylinders obtained with such a process.

### TECHNICAL FIELD

The present invention relates to a new process for preparing polymethylmethacrylate (PMMA) comprising nanometric particles of gadolinium oxide (Gd₂O₃) at high concentration, and plates or cylinders obtained with such a process.

### BACKGROUND

Gadolinium oxide is an important chemical compound that, once incorporated into polymeric materials in the form of nanometric particles, can have unique and very relevant applications.

Gadolinium compounds soluble in liquid methylmethacrylate (MMA) which are also pure from the point of view of radioactive contaminants and available on the hundred-kilogram scale, are not present in the literature. Therefore, in order to produce PMMA plates containing nano-structured gadolinium oxide at high concentrations it is necessary to try to create a dispersion of nanometric particles of gadolinium oxide in liquid MMA and then start the polymerization process.

Unfortunately, it is particularly difficult to use dispersions of nanometric particles of gadolinium oxide to optimize the polymerization process.

The problem of the formation of nanometric particle aggregates is known in literature and a possible solution is treating the surface of the grains with appropriate chemical species. The aim is to create a repulsive force between the grains and obtain a stable dispersion over as long time scales as possible.

This problem is even more complex when a distribution of gadolinium oxide at high concentration, greater than 0.1% by mass with respect to the polymer, is required. A literature article that is particularly relevant to this technical problem is “Nanoparticle-doped large area PMMA plates with controlled optical diffusion” (J. Mater. Chem. C, 2013, 1, 2927).

The article suggests a so-called “non-hybrid” approach based on the treatment with surfactants and subsequent incorporation into the PMMA polymer.

However, the procedure described in the cited article is not applicable for producing samples that are a few centimetres thick but is valid only for thin films, and, above all, it does not describe the dispersion in the liquid monomer, to be polymerized subsequently, but only the incorporation into pellets of the polymer already formed.

### OBJECTS AND SUMMARY OF THE INVENTION

An object of the present invention is to overcome the drawbacks of the prior art. In particular, an object of the present invention is to realize a new industrial process for preparing polymethylmethacrylate containing nanometric particles of gadolinium oxide (Gd₂O₃) between 0.1 and 4.0% by mass with respect to the polymer.

Another object of the present invention is to have plates of polymethylmethacrylate containing nanometric particles of gadolinium oxide (Gd₂O₃) between 0.1 and 4.0% by mass with respect to the polymer having a thickness from 2 to 30 centimetres.

A further object of the present invention is to be able to use polymethylmethacrylate plates containing nanometric particles of gadolinium for neutron detectors for monitoring nuclear reactors, for environmental monitoring, for controlling nuclear non-proliferation standards, for control systems of machines for oncological or medical physical adrotherapy and for neutron detectors for dark matter research experiments.

These and further objects of the present invention are achieved by means of a process incorporating the features of the appended claims, which form an integral part of the present description.

According to a first aspect of the present invention, the process for preparing polymethylmethacrylate containing nanometric particles of gadolinium oxide (Gd₂O₃) comprises the following steps:
a. Treating gadolinium oxide, by sonication, with a non-ionic surfactant between 0.1 and 4.0% by mass with respect to the surfactant, dissolved in an apolar solvent for obtaining a suspension;
b. Merging the suspension obtained from step a. to methylmethacrylate (MMA), first depured by inhibitors, at room temperature for obtaining a preparation;
c. Pre-polymerizing the preparation obtained from step b. at a temperature comprised between 70° C. and 100° C. by a primary initiator for obtaining a pre-polymerized product;
d. Polymerizing the pre-polymerized product obtained from step c. by a secondary initiator for obtaining a polymerized product;
e. Treating the polymerized product obtained from step d. at a temperature comprised between 40° C. and 90° C. for obtaining the final product.

In a preferred embodiment of the invention the nanometric particles of gadolinium oxide (Gd₂O₃) are present between 0.1% and 4.0% by mass with respect to the MMA monomer, even more preferably between 1.0% and 3.0%.

The nanometric particles of gadolinium oxide used in the process according to the present invention have dimension comprised between 10 nm and 100 nm, preferably between 20 nm and 50 nm. In a particularly preferred aspect, the dimension of the nanometric particles of gadolinium oxide is 30 nm.

Advantageously, the non-ionic surfactant is a chemical product characterized by a hydrophilic-lipophilic balance HLB comprised between 10 and 25 and by the length of the alkyl chain between 12 and 64 carbon atoms. Preferably the non-ionic surfactant in its structure has an alkyl chain, an aromatic ring and a given number of poly(oxyethylene) groups. By way of example, the poly(oxyethylene) groups may be 5 or 10.

In the first case the non-ionic surfactant is poly(oxyethylene)nonylphenyl ether ((C₂H₄O)₅·C₁₅H₂₄O), e.g. marketed as Igepal CO-520, while in the second case the non-ionic surfactant is poly(oxyethylene)octylphenyl ether ((C₁₄H₂₂O(C₂H₄O) n with n=9-10), e.g. marketed as Triton X100.

From some tests carried out, the best apolar solvent for the dispersion of the gadolinium particles in the surfactant would appear to be 2-butanone, but a different apolar analogue solvent can be used to implement the process of the invention.

With regard to the pre-polymerization of step c., this is preferably carried out at a temperature comprised between 75° C. and 90° C., more preferably at 80° C.

Among the initiators soluble in organic solvents, the most commonly used are benzoyl peroxide (BPO), lauroyl peroxide, azobisisobutyronitrile (AIBN) and hydroperoxides. Preferably, the process of the present invention uses azobisisobutyronitrile (AIBN) as the primary initiator and lauroyl peroxide as the secondary initiator.

With regard to step e., the heat treatment is carried out at a temperature comprised between 45° C. and 70° C., preferably at 55° C. for a time comprised between 20 and 40 hours, preferably 24 hours.

However, it is possible to change the temperature and consequently the heat treatment times according to the thickness of the desired plate.

The final product obtained at the end of step e. is an element, for example a plate or a cylinder, of polymethylmethacrylate comprising nanometric particles of gadolinium oxide (Gd₂O₃) between 0.1% and 4.0% by mass, preferably between 1 and 3%, even more preferably between 1.1% and 2.0% by mass with respect to polymethylmethacrylate.

With regard to a second aspect of the present invention it concerns a polymethylmethacrylate element (in particular a plate or a cylinder) comprising nanometric particles of gadolinium oxide (Gd₂O₃) between 0.1% and 4.0% by mass, preferably between 1.0% and 3.0%, even more preferably between 1.1% and 2.0% by mass with respect to polymethylmethacrylate prepared according to the process described above. Advantageously, the plates obtained with the process of the invention have a thickness comprised between 2 and 30 cm, preferably have a thickness of at least 5 cm and even more preferably greater than 10 cm.

A further aspect of the present invention concerns the use of polymethylmethacrylate plates comprising particles of gadolinium oxide (Gd₂O₃) between 0.1 and 4.0% by mass, preferably between 1.0 and 3.0% by mass for neutron detectors for monitoring nuclear reactors, for environmental monitoring, for controlling nuclear non-proliferation standards, for the control systems of machines for oncological or medical physical adrotherapy and for neutron detectors for research experiments.

Unless otherwise defined, all the terms of the art, notations and other scientific terms used herein are intended to have the meanings commonly understood by those skilled in the art to which this description belongs. In some cases, terms with commonly understood meanings are defined herein for clarity and/or ready reference; the inclusion of such definitions in the present disclosure should therefore not be construed as representative of a substantial difference from what is generally understood in the art.

The terms “comprising”, “having”, “including” and “containing” are to be understood as open terms (i.e. the meaning “comprising, but not limited to”) and are to be considered as a support also for terms such as “consisting essentially of”, “consisting essentially of”, “consisting of” or “consisting of”.

The use of “for example”, “etc.”, “or” indicates non-exclusive alternatives without limitation, unless otherwise indicated. The use of “includes” means “includes, but not limited to” unless otherwise indicated.

### BRIEF DESCRIPTION OF THE DRAWINGS

Further features and advantages of the present invention will be more evident from the following description of some preferred embodiments thereof made with reference to the appended drawings.

In such drawings:

FIG. 1 schematically represents with blocks a preferred embodiment of the process according to the present invention;

FIG. 2 shows the verification of the functionalization of the nanometric particles of gadolinium oxide through infrared spectroscopy measurements;

FIG. 3 shows DLS (Dynamic Light Scattering) measurements on some samples before polymerization to verify the dispersion of particles of gadolinium oxide in the apolar solvent;

FIG. 4 shows an image of the final product

FIGS. 5a and 5b show the characterization of the sample performed with thermogravimetric analysis at various times.

### DETAILED DESCRIPTION OF THE INVENTION

While the invention is susceptible to various modifications and alternative constructions, a preferred embodiment is shown in the figures and will be described below in detail. It must in any case be understood that there is no intention to limit the invention to the specific embodiment illustrated, but, on the contrary, the invention intends covering all the modifications, alternative and equivalent constructions that fall within the scope of the invention as defined in the claims.

The use of “for example”, “etc.”, “or” indicates non-exclusive alternatives without limitation, unless otherwise indicated. The use of “comprises” and “includes” means “comprises or includes, but not limited to” unless otherwise indicated.

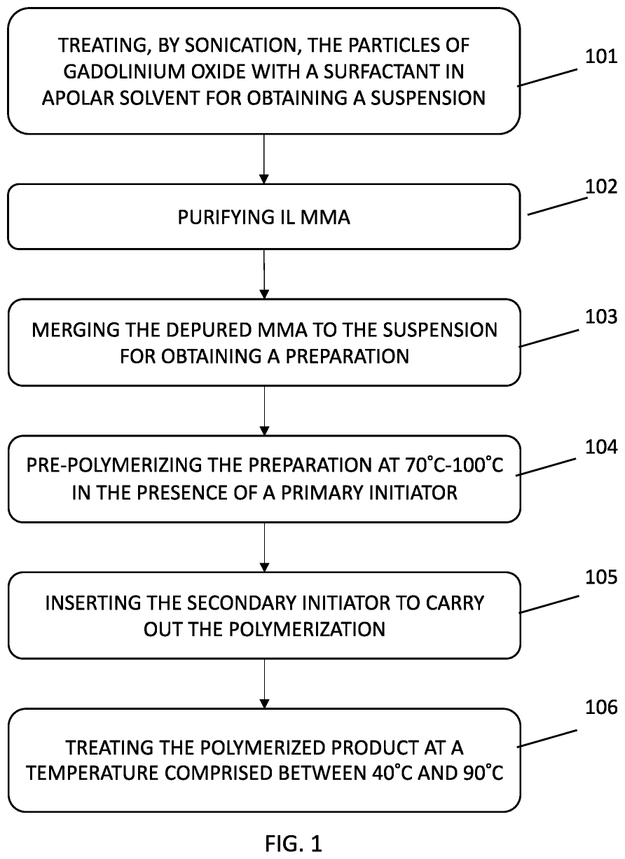

The various steps of the process are shown in the process diagram illustrated in FIG. 1.

In step a. of the process 101, gadolinium oxide is treated, by sonication, with a non-ionic surfactant dissolved in an apolar solvent where gadolinium oxide is present from 0.1 to 4.0% by mass, preferably between 1.0 and 3.0%, even more preferably between 1.1% and 2.0% by mass.

Since gadolinium oxide is not soluble in methylmethacrylate (MMA), the liquid monomer from which the PMMA is obtained, a colloidal dispersion of the nanometric particles within the MMA is made. In order to obtain a uniform distribution of nanometric particles of gadolinium oxide at high concentration, greater than 0.1% by mass, it is necessary to treat the nanometric particles in advance, in such a way as to minimize the formation of aggregates and prevent their flocculation. This is done through a molecular functionalization of the surface of the nanometric particles, aimed at creating repulsive electrostatic forces and steric dimension factors, which favour the stabilization of the nanometric particles.

In particular, with regard to the treatment of gadolinium oxide, commercial surfactants with different ionic properties and with alkaline chains of different lengths may be used.

The nanometric particles of gadolinium oxide used in the process according to the present invention have dimension comprised between 10 nm and 100 nm, preferably between 20 nm and 50 nm. In a particularly preferred aspect the dimension of the nanometric particles of gadolinium oxide have a dimension of 30 nm.

Advantageously, the non-ionic surfactant is a chemical product characterized by a hydrophilic-lipophilic balance HLB comprised between 10 and 25 and by the length of the alkyl chain between 12 and 64 carbon atoms. Preferably in its structure it has an alkyl chain, an aromatic ring and a given number of poly(oxyethylene) groups. By way of example, the poly(oxyethylene) groups may be 5 or 10.

In the first case the non-ionic surfactant is poly(oxyethylene)nonylphenyl ether ((C2H4O)5·C15H24O), marketed as Igepal CO-520, while in the second case the non-ionic surfactant is polyo(oxyethylene)octylphenylether (C14H22O(C2H4O) n with n=9-10), marketed as Triton X100.

In a particularly preferred aspect, poly(oxyethylene)nonylphenyl ether ((C2H4O)5·C15H24O), whose trade name is Igepal CO-520, was chosen. It is a non-ionic surfactant that allows to obtain stable Gd2O3 nano-grain dispersions in liquid solvents for about 1 hour.

For the application of the invention, however, it was necessary to merge the surface treatment of the nanometric particles to an adequate polymerization procedure of the MMA, so as to obtain high concentration samples in Gd2O3 (between 0.1% and 4.0% by mass) and high thickness plates (between 2 and 20 cm).

The procedure provides, after purification of the MMA 102 to remove the polymerization inhibitors, a first step of functionalization of the nanometric particles. This takes place by sonication of gadolinium oxide with the commercial surfactant Igepal CO 520, in solution with 2-butanone. The sonicator “Sonic Ruptor 400 Ultrasonic Homogenizer” was used to carry out this first operation. Sonication times can be variable; a 15-minute treatment is sufficient.

In general, apolar solvents can be used instead of 2-butanone; 2-butanone has been chosen for its boiling temperature (79.6° C.) which allows it to evaporate in the pre-polymerization step, but which is high enough so as not to create bubbles in the polymerization step.

In a particularly preferred case the surfactant is added in the same concentration as the oxide, i.e. 1.0% with respect to the mass of MMA. 2-butanone is instead in a ratio of 1:3 with respect to the volume of MMA. However, both the amount of surfactant and that of 2-butanone can vary slightly: in particular, the amount of surfactant can be chosen in a range that varies between half and twice the amount of oxide used, while 2-butanone must be at least in a ratio of 1:4 with respect to the volume of MMA. It is possible to use a greater amount of 2-butanone, initially obtaining a more fluid dispersion, but it is then necessary to extend the boiling and cooking times appropriately to allow the solvent to evaporate.

The functionalization of the nanometric particles of gadolinium oxide was verified by infrared (IR) spectroscopy measurements.

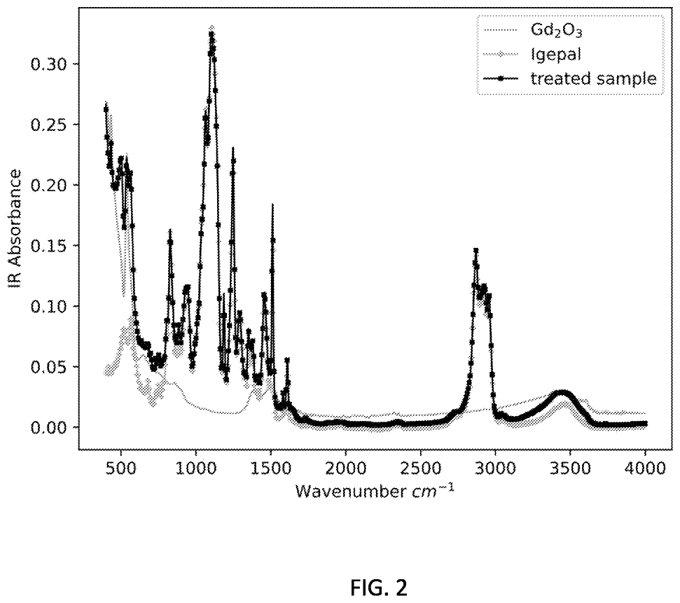

FIG. 2 shows IR spectra of three different compounds: the solid grey line is the spectrum of pure gadolinium oxide, without any treatment; the grey line with a circle is the spectrum of pure surfactant and finally the black line with a square represents the spectrum of one of the samples obtained after functionalization, but before polymerization. It can be observed that the spectrum of the treated sample has both the gadolinium oxide and Igepal CO 520 peaks. This indicates the presence of the surfactant in the sample and therefore a good functionalization of the surface of the nanometric particles.

In addition to the IR spectroscopy measurements, DLS (Dynamic Light Scattering) measurements were made on some samples before polymerization. In particular the 2-butanone dispersion, after sonication, was appropriately diluted and measured.

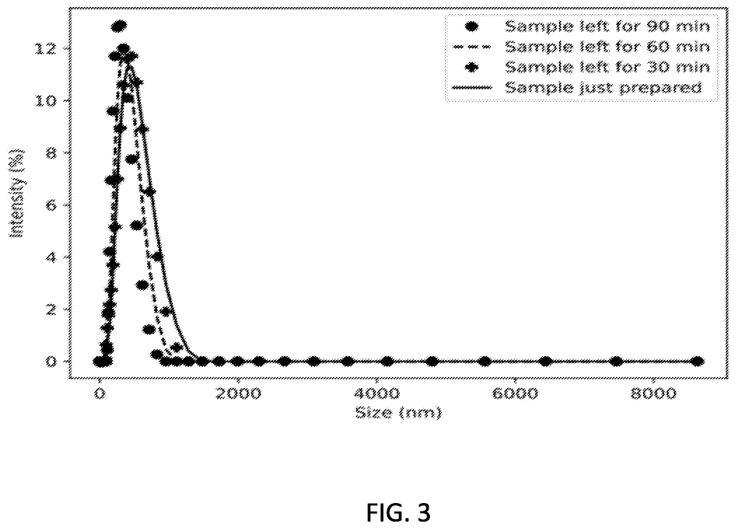

As can be seen in FIG. 3, several sets of measurements are reported: the first obtained immediately after sonication, when the dispersion was at the highest level of homogeneity, the other three were instead obtained after 30, 60 and 90 minutes respectively from the end of sonication. During these time intervals the sample was allowed to rest. Since the three successive sets of measurements show a result similar to the first one, it means that the dispersion has remained stable (the average dimension of the dispersed aggregates is substantially the same), so the nanometric particles have not settled on the bottom.

The second step of the process is to merge the suspension containing gadolinium oxide to the liquid MMA at room temperature 103. The preparation thus obtained is heated on a plate and mixed, to facilitate the exit of bubbles. When the preparation reaches a temperature of 80° C., the primary initiator 104, (in a preferred aspect of the invention AIBN, azobisisobutyronitrile) is added and the pre-polymerization step begins. The amount of initiator used was usually 100 ppm, but it can be increased up to 200 ppm by adapting the exhaustion times.

The increase in temperature, in addition to activating the initiator, allows the elimination of 2-butanone from the compound by evaporation. The progressive increase in viscosity promotes the homogeneous dispersion of the nanometric particles and the stability of the colloid, even on time scales of several hours. During this step it is necessary to calibrate the heating times in such a way as to exhaust the production of gas by the primary initiator, which would cause the formation of bubbles in the final product. Generally it is sufficient to wait between 5 and 15 minutes since activation of the initiator, preferably between 7 and 10 minutes). In case AIBN is used this last process takes place around 96° C. and is easily recognizable thanks to a very intense boiling, as if the liquid became effervescent.

In the third step of the process 105 heating is interrupted and the secondary initiator is incorporated into the sample, in a preferred aspect of the invention lauroyl peroxide. In most of our samples, amounts of lauroyl peroxide comprised between 400 ppm and 600 ppm have been used.

The last step of the procedure 105 consists of the heat treatment of the sample at low temperature, to complete polymerization 106. To obtain 5 cm thick samples the polymer was treated at 55° C. for 24 hours, in lidless glass moulds. Both the time and the temperature of the heat treatment may vary depending on the geometry of the sample.

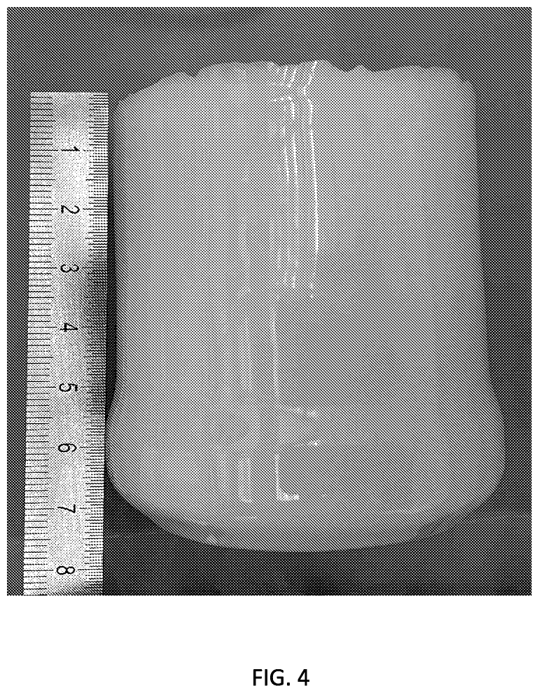

The procedure described has already been tested on a laboratory scale and several samples have been made which are all satisfactory as shown in FIG. 4. As can be seen from FIG. 4, the cylindrical sample (7 cm thick) has excellent uniformity in the distribution of the nanometric particles and a glassy and bubble-free appearance.

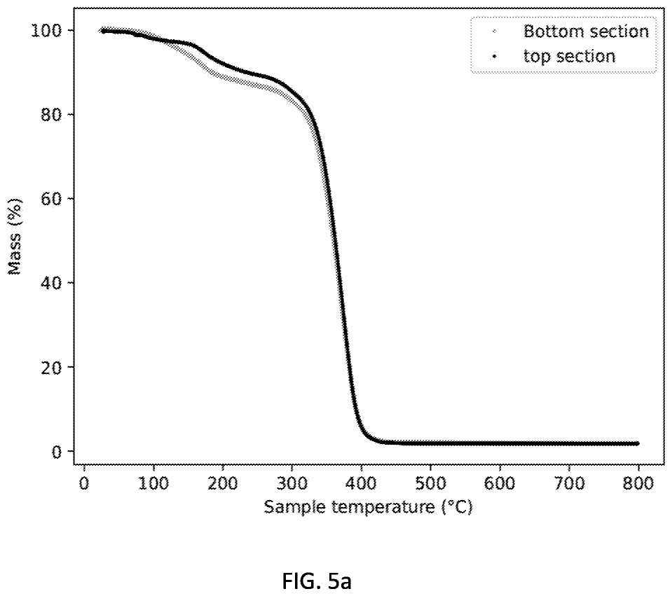

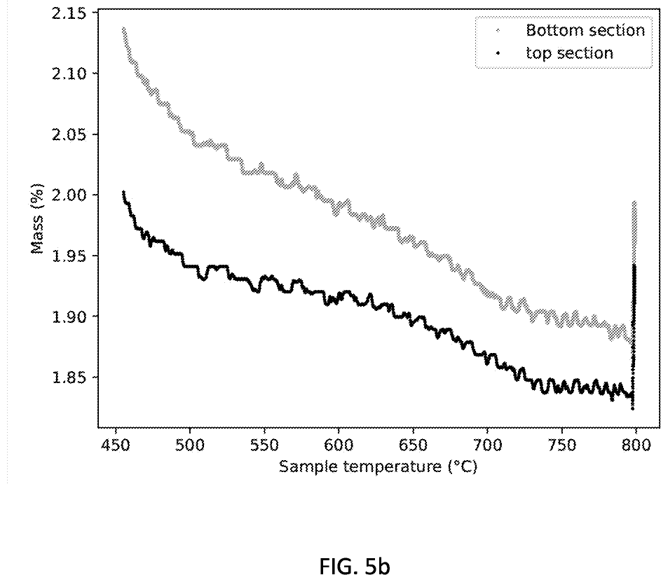

Characterizations made with thermo-gravimetric analysis (FIGS. 5a and 5b) and calcination measurements show a good sample uniformity along the vertical direction. An example of measurement carried out at two different points in the sample can be seen. The amount of final residue, corresponding to the amount of gadolinium oxide, is comprised between 1.85% and 1.95% and therefore corresponds to the expectations and shows excellent uniformity throughout the sample examined.

Below is an example of a preferred embodiment that will make it even clearer how the invention allows to achieve the set objectives. This example is not to be interpreted in a limiting sense and the invention thus conceived is susceptible to numerous modifications and variations all falling within the scope of the present invention as it results from the appended claims.

### Example 1

200 ml of MMA were purified using an alumina column. The total mass of MMA, considering a density of 0.94 g/ml is 188 g.

1.88 g of gadolinium oxide and 1.88 g of Igepal-CO 520 were then prepared. These were combined with 67 ml of 2-butanone and kept under stirring for 15 minutes using the 50-power Sonic Ruptor 400 Ultrasonic Homogenizer. The suspension was then merged to the depured MMA at room temperature and stirred manually with a glass rod.

The obtained preparation was heated with a C-Mag hs 7, IKA plate set at a temperature of 250° C. The temperature of the preparation was constantly monitored. Upon reaching 80° C., 0.019 g, corresponding to 100 ppm, of primary initiator (AIBN) were added. The preparation was manually mixed with a glass rod. After a few minutes, when the temperature reached about 92° C., a violent boiling process, similar to effervescence, was triggered due to the activation of AIBN, with consequent production of nitrogen. 9 minutes were timed from triggering and the plate temperature was lowered to 200° C. The pre-polymerized product is more frequently manually mixed to have a homogeneous pre-polymerization process. At the end of 9 minutes the Becker containing the pre-polymerized product was removed from the plate and the secondary initiator (0.11 g of Luperox (600 ppm)) was added. The pre-polymerized product was then stirred one last time to facilitate the dissolution of the Luperox and was transferred to a glass mould. Finally, the mould was placed in the oven, pre-heated to 55° C., where the polymerization was completed in 24 h.

### (Comparative) Example 2

The procedure was performed as substantially described in Example 1, but pre-polymerization took place at 105° C. The formation of rubbery agglomerates was observed, due to the non-uniformity of the polymerization, with consequent defects in the distribution of gadolinium oxide.

### (Comparative) Example 3

The procedure was performed as substantially described in Example 1, but pre-polymerization took place at 70° C. Numerous small-sized bubbles were observed in the final samples caused by nitrogen produced by non-exhausted AIBN residues.

1. Process for preparing polymethylmethacrylate, containing nanometric particles of gadolinium oxide (Gd₂O₃) comprising the following steps:
a. Treating gadolinium oxide, by sonication, with a non-ionic surfactant between 0.1% and 4.0%, by mass with respect to the surfactant and dissolved in an apolar solvent for obtaining a suspension (101);
b. Merging the suspension obtained from step a. to methylmethacrylate (MMA) first depured by inhibitors (102) at room temperature for obtaining a preparation (103);
c. Pre-polymerizing the preparation obtained from step b at a temperature comprised between 70° C. and 100° C. by a primary initiator for obtaining a pre-polymerized product (104);
d. Polymerizing the pre-polymerized product obtained from step c by a secondary initiator for obtaining a polymerized product (105);
e. Treating the polymerized product obtained from step d. at a temperature comprised between 40° C. and 90° C. for obtaining the final product (106).

2. Process for preparing polymethylmethacrylate, containing nanometric particles of gadolinium oxide (Gd₂O₃) according to claim 1 wherein said nanometric particles of gadolinium oxide have dimension comprised between 10 nm and 100 nm.

3. Process for preparing polymethylmethacrylate, containing nanometric particles of gadolinium oxide (Gd₂O₃) according to claim 1 wherein the apolar solvent is 2-butanone.

4. Process for preparing polymethylmethacrylate containing nanometric particles of gadolinium oxide (Gd₂O₃) according to claim 1 wherein the non-ionic surfactant is a chemical product characterized by a hydrophilic-lipophilic balance HLB comprised between 10 and 25 and by the length of alkyl chain between 12 and 64 carbon atoms.

5. Process for preparing polymethylmethacrylate, containing nanometric particles of gadolinium oxide (Gd₂O₃) according to claim 3 wherein the non-ionic surfactant is poly(oxyethylene)nonylphenyl ether ((C₂H₄O)₅·C₁₅H₂₄O).

6. Process for preparing polymethylmethacrylate containing nanometric particles of gadolinium oxide (Gd₂O₃) according to claim 1 wherein the primary initiator is azobisisobutyronitrile (AIBN).

7. Process for preparing polymethylmethacrylate, containing nanometric particles of gadolinium oxide (Gd₂O₃) according to claim 1 wherein the secondary initiator is lauroyl peroxide.

8. Element, in particular plate or cylinder, of polymethylmethacrylate comprising nanometric particles of gadolinium oxide (Gd₂O₃) between 0.1% and 4% by mass, preferably between 1.0 and 3.0% by mass with respect to polymethylmethacrylate.

9. Element according to claim 7, characterized by having a thickness comprised between 2 and 30 cm.
